(19) United States
(12) Patent Application Publication
(10) Pub. No.: US 2026/0160622 A1
(43) Pub. Date: Jun. 11, 2026

(54) FLUIDIC TACTILE SENSOR WITH TUNABLE GAP

(71) Applicant: Sanctuary Cognitive Systems (USA) Corporation, Wilmington, DE (US)

(72) Inventors: Jeremy A Fishel, Chico, CA (US); William Cortez, Chico, CA (US); Jason L Vasquez, Chico, CA (US)

(21) Appl. No.: 19/181,836

(22) Filed: Apr. 17, 2025

Related U.S. Application Data
(60) Provisional application No. 63/663,096, filed on Jun. 22, 2024.

(51) Int. Cl. G01L 7/08; G01L 19/00; G01L 19/14

(52) U.S. Cl. CPC G01L 7/082; G01L 19/0007; G01L 19/0061; G01L 19/143; G01L 19/144; G01L 19/149

(57) ABSTRACT

A tactile sensor includes a cell containing a fluid medium, a core having a ventral surface forming a first boundary of the cell, and an elastic skin having an inner surface forming a second boundary of the cell. The inner surface has a raised surface texture protruding into the cell. A force applied to the elastic skin deforms the elastic skin and causes a change in fluid pressure inside the cell. The tactile sensor includes a pressure transducer that is arranged to measure the fluid pressure inside the cell.

### CROSS-REFERENCE TO RELATED APPLICATIONS

This application claims the benefit of U.S. Provisional Application No. 63/663096, filed Jun. 22, 2024, the content of which is incorporated herein by reference.

### FIELD

The field generally relates to robotics and particularly to tactile sensing in robotics.

### BACKGROUND

Robots are machines that can sense their environments and perform tasks autonomously or semi-autonomously or via teleoperation. A humanoid robot is a robot or machine having an appearance and/or character resembling that of a human. Humanoid robots can be designed to function as team members with humans in diverse applications, such as construction, manufacturing, monitoring, exploration, learning, and entertainment. Humanoid robots can be particularly advantageous in substituting for humans in environments that may be dangerous to humans or uninhabitable by humans.

### SUMMARY

In a representative example, a tactile sensor includes a cell containing a fluid medium. The tactile sensor includes a core having a ventral surface and a dorsal surface. The ventral surface forms a first boundary of the cell. The tactile sensor includes an elastic skin having an inner surface and an outer surface. The inner surface of the elastic skin is in opposing relation to the ventral surface of the core and forms a second boundary of the cell. The inner surface includes a raised surface texture that protrudes into the cell. A force applied to the elastic skin deforms the elastic skin and causes a change in fluid pressure inside the cell. The tactile sensor includes a pressure transducer that is arranged to measure the fluid pressure inside the cell.

### BRIEF DESCRIPTION OF THE DRAWINGS

FIG. 1 is a projection view of a tactile sensor.

FIG. 2A is a cross-sectional view of the tactile sensor shown in FIG. 1 and illustrates an elastic skin having an inner surface including a raised surface texture.

FIG. 2B is a cross-sectional view of the tactile sensor shown in FIG. 1, taken along line 2B-2B as depicted in FIG. 2A.

FIG. 3 is a cross-sectional view of the tactile sensor shown in FIG. 1 and illustrates an elastic skin having an inner surface including a raised surface texture that is different from the one shown in FIG. 2A.

FIG. 4 illustrates the raised surface texture shown in FIG. 2A engaging a ventral surface of a core of the tactile sensor in an engaged position.

FIG. 5A is a cross-sectional view of the tactile sensor shown in FIG. 1 with an inflation port in a core of the tactile sensor.

FIG. 5B is a cross-sectional view of the tactile sensor shown in FIG. 1 with an inflation port in a core of the tactile sensor connected to a pressure communication port in the core.

FIG. 5C is a cross-sectional view of the tactile sensor shown in FIG. 1 with an inflation port in a core of the tactile sensor and a valve arranged in the inflation port.

FIG. 6 is a projection view of the tactile sensor shown in FIG. 1 attached to a distal phalanx of a robotic digit.

### DETAILED DESCRIPTION

### General Considerations

For the purpose of this description, certain specific details are set forth herein in order to provide a thorough understanding of disclosed technology. In some cases, as will be recognized by one skilled in the art, the disclosed technology may be practiced without one or more of these specific details, or may be practiced with other methods, structures, and materials not specifically disclosed herein. In some instances, well-known structures and/or processes associated with robots have been omitted to avoid obscuring novel and non-obvious aspects of the disclosed technology.

All the examples of the disclosed technology described herein and shown in the drawings may be combined without any restrictions to form any number of combinations, unless the context clearly dictates otherwise, such as if the proposed combination involves elements that are incompatible or mutually exclusive. The sequential order of the acts in any process described herein may be rearranged, unless the context clearly dictates otherwise, such as if one act or operation requests the result of another act or operation as input.

In the interest of conciseness, and for the sake of continuity in the description, same or similar reference characters may be used for same or similar elements in different figures, and description of an element in one figure will be deemed to carry over when the element appears in other figures with the same or similar reference character, unless stated otherwise. In some cases, the term “corresponding to” may be used to describe correspondence between elements of different figures. In an example usage, when an element in a first figure is described as corresponding to another element in a second figure, the element in the first figure is deemed to have the characteristics of the other element in the second figure, and vice versa, unless stated otherwise.

The word “comprise” and derivatives thereof, such as “comprises” and “comprising”, are to be construed in an open, inclusive sense, that is, as “including, but not limited to”. The singular forms “a”, “an”, “at least one”, and “the” include plural referents, unless the context dictates otherwise. The term “and/or”, when used between the last two elements of a list of elements, means any one or more of the listed elements. The term “or” is generally employed in its broadest sense, that is, as meaning “and/or”, unless the context clearly dictates otherwise. When used to describe a range of dimensions, the phrase “between X and Y” represents a range that includes X and Y. As used herein, an “apparatus” may refer to any individual device, collection of devices, part of a device, or collections of parts of devices.

The term “coupled” without a qualifier generally means physically coupled or lined and does not exclude the presence of intermediate elements between the coupled elements absent specific contrary language. The term “plurality” or “plural” when used together with an element means two or more of the element. Directions and other relative references (e.g., inner and outer, upper and lower, above and below, and left and right) may be used to facilitate discussion of the drawings and principles but are not intended to be limiting.

The headings and Abstract are provided for convenience only and are not intended, and should not be construed, to interpret the scope or meaning of the disclosed technology.

### Example I—Overview

Described herein is a tactile sensor that can be attached to a surface of an object to provide the object with tactile sensing at the surface. The tactile sensor can be adapted for attachment to any portion of an external surface of the robot, providing the robot with the ability to be sensitive to contacts and collisions. The tactile sensor is a fluid-based sensor that measures the response of fluid pressure in a cell to contact forces. The tactile sensor uses a raised surface texture of an elastic structure to widen the dynamic force range of the tactile sensor.

### Example II—Tactile Sensor

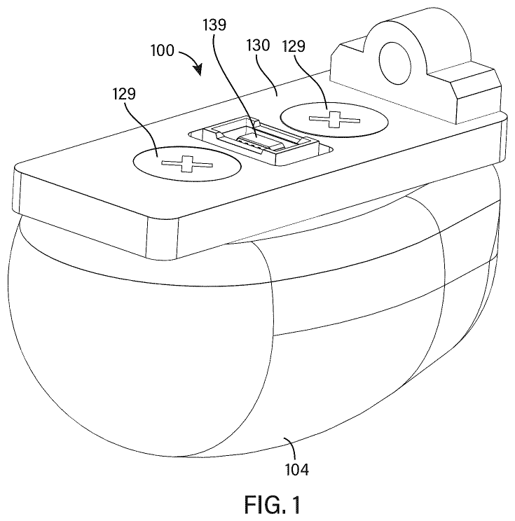

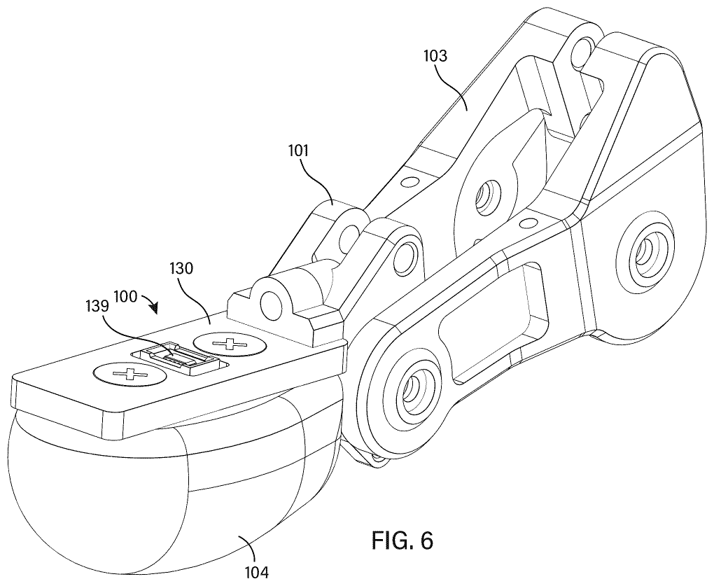

FIGS. 1-5 illustrate an exemplary tactile sensor 100 that can be attached to a surface of interest to enable tactile sensing at the surface. In some examples, the surface of interest can be any external surface of a robot where tactile sensing is desired (e.g., any external surface of a robotic hand). In the illustrated examples, the tactile sensor 100 is shaped like a fingertip and can be attached to a distal phalanx of a robotic finger (as shown, for example, in FIG. 6). In other examples, the tactile sensor 100 could have a different shape other than shown in FIGS. 1-5 for attachment to other parts of a robot.

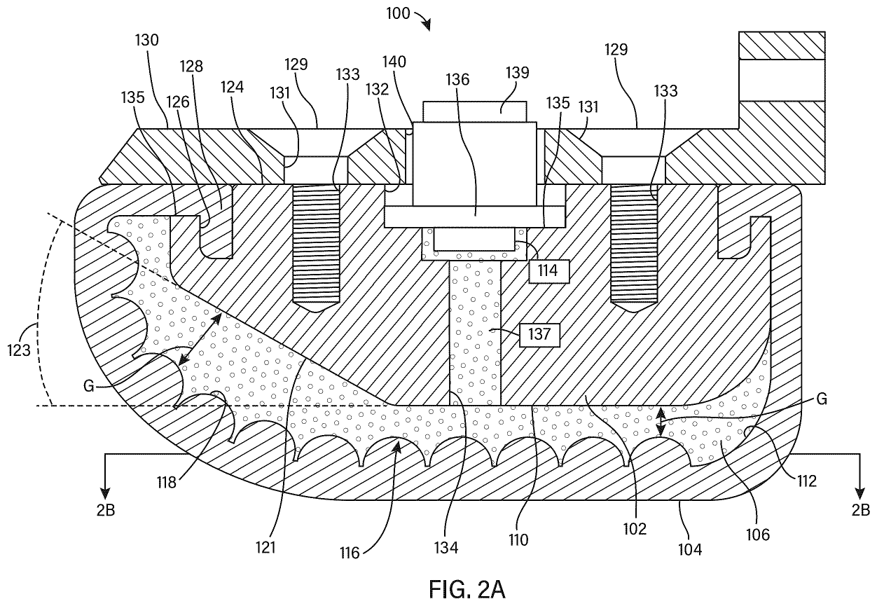

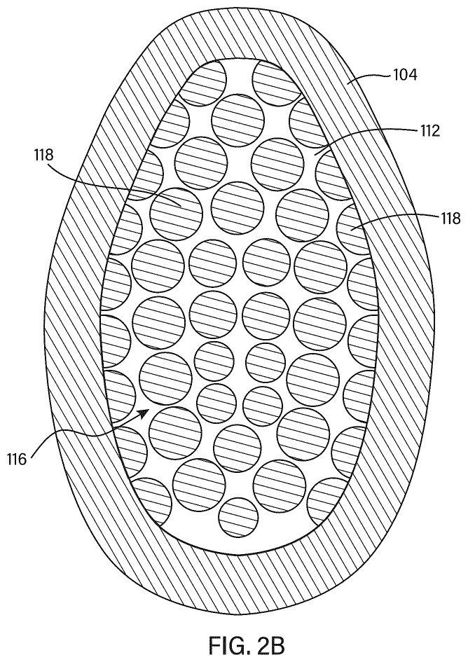

As shown more clearly in FIG. 2A, the tactile sensor 100 includes a core 102, an elastic skin 104 coupled to the core 102, and a cell 106 occupying a space between the core 102 and the elastic skin 104. The cell 106 is bounded by a ventral surface 110 of the core 102 and an inner surface 112 of the elastic skin 104 that is in opposing relation to the ventral surface 110 of the core 102. The cell 106 contains a compressible fluid (e.g., a gaseous medium). In some examples, the cell 106 contains air, e.g., ambient air or compressed air.

When a contact force is applied to the elastic skin 104 (e.g., by touching or colliding with the elastic skin from the exterior of the tactile sensor), the elastic skin 104 deforms, causing a change in the volume of the cell 106, which can result in a change in the fluid pressure inside the cell 106. The tactile sensor 100 includes a pressure transducer 114 arranged to sense fluid pressure changes inside the cell 106. The pressure measurements can be mapped to tactile sensing data (e.g., the amount of contact force being applied to the elastic skin).

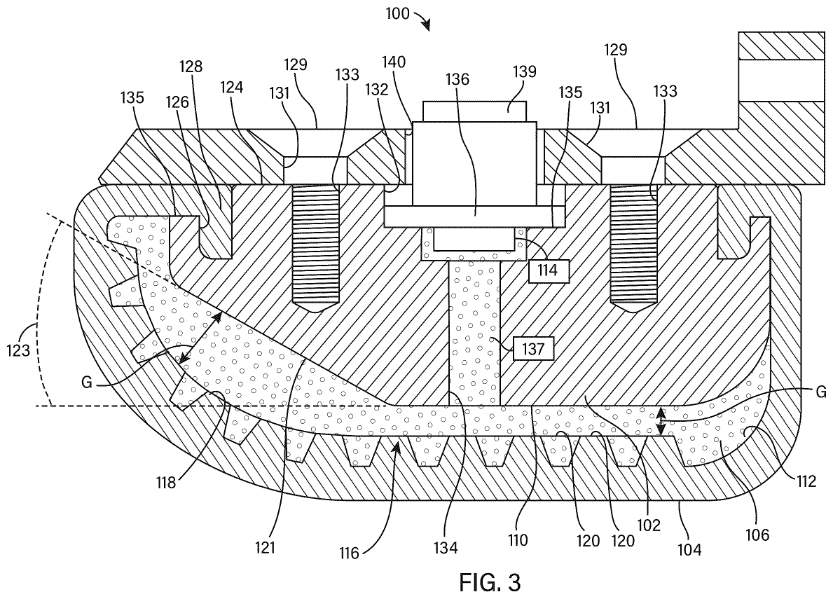

In the illustrated examples, the inner surface 112 of the elastic skin 104 includes a raised surface texture 116 that protrudes into the cell 106. In one example, the raised surface texture 116 includes discrete 3D (three-dimensional) structures arrayed across the inner surface 112 of the elastic skin 104. The discrete 3D structures can be arranged in any suitable array pattern (e.g., triangular pattern, square pattern, hexagonal pattern, or irregular pattern) and have any suitable profile (e.g., spherical profile, cylindrical profile, or frustoconical profile). FIGS. 2A and 2B show an example where the raised surface texture 116 includes discrete 3D structures 118 with a spherical profile. In another example, the raised surface texture 116 can include intersecting 3D structures extending across the inner surface of the elastic skin 104. The intersecting 3D structures can form any suitable grid pattern and have any suitable cross-sectional shape (e.g., square cross-section or tapered cross-section). The intersecting 3D structures may be linear 3D structures or nonlinear 3D structures. FIG. 3 shows an example where the raised surface texture 116 includes linear 3D structures 120 intersecting to form a grid (e.g., a waffle structure or a crisscross pattern).

The raised surface texture 116 has a free position in which the 3D structures in the raised surface texture 116 are separated from the ventral surface 110 of the core 102 by a tuning gap G (see FIGS. 2A and 3). A portion of the raised surface texture 116 may also be described as being in a free position if the portion is separated from the ventral surface 110 of the core 102 by the tuning gap G. The tuning gap G may be uniform across the cell 106 or may be nonuniform across the cell 106. The tuning gap G represents a distance through which a corresponding 3D structure of the raised surface texture 116 may travel before engaging the ventral surface 110 of the core 102. The raised surface texture 116 is in an engaged position when any portion of the raised surface texture 116 is engaged with (e.g., contacts) the ventral surface 110 of the core 102. A portion of the raised surface texture 116 that is engaged with the ventral surface 110 of the core 102 may also be described as being in an engaged position.

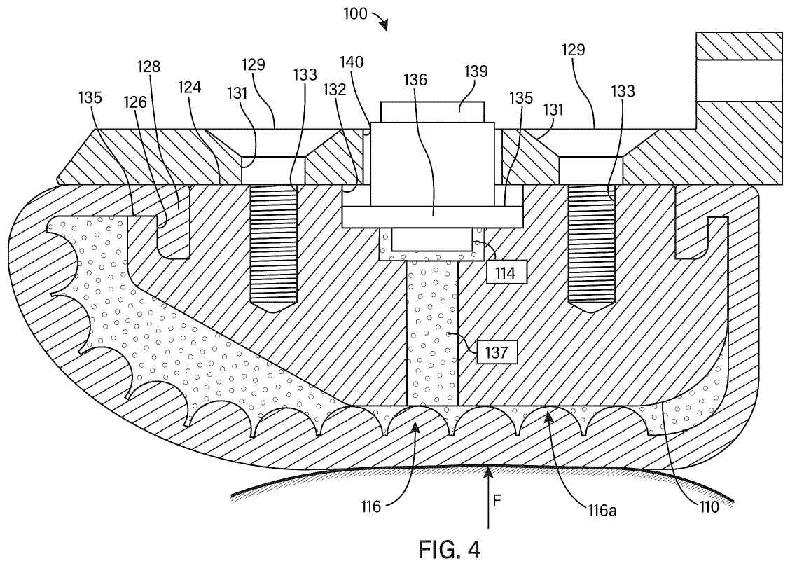

When any portion of the raised surface texture 116 engages the ventral surface 110 of the core 102 in response to applying a contact force to the elastic skin 104, the portion of the raised surface texture 116 engaging the ventral surface 110 of the core 102 forms a compression spring that resists the contact force applied to the elastic skin 104. FIG. 4 shows an example of applying a contact force F to the elastic skin 104 that results in a portion 116a of the raised surface texture 116 engaging the ventral surface 110 of the core 102. As the contact force F is increased, the compression spring formed by the portion 116a deforms. The maximum deflection of the compression spring (or maximum spring compression) corresponds to the largest force to which the tactile sensor 100 can be sensitive. Thus, the raised surface texture 116 has the effect of widening the dynamic range of the tactile sensor 100 (i.e., widening beyond the range that is available with just the fluid in the cell 106). When the contact force is released from the elastic skin 104, the stored energy in the compression spring releases the portion 116a of the raised surface texture 116 from the ventral surface 110 of the core 102, which can act to return the elastic skin 104 to a neutral position away from the core 102 (e.g., as shown in FIG. 2A).

The dynamic range of the tactile sensor 100 is characterized by two different stiffness ranges, a low-stiffness range that is impacted by the height of the tuning gap G and a high-stiffness range that is impacted by the height of the raised surface texture 116. In a given portion of the tactile sensor where the tuning gap G is non-zero (e.g., the 3D structures in the given portion do not engage the ventral surface 110 of the core 102, or the given portion is in a free position), the tactile sensor is in the low-stiffness range where the stiffness of the tactile sensor responds to the height of the tuning gap in the given portion (e.g., becomes stiffer as the height of the tuning gap decreases and the fluid in the tuning gap is compressed). In a given portion of the tactile sensor where the tuning gap is zero (e.g., the 3D structures in the given portion engage the ventral surface 110 of the core 102, or the given portion is in an engaged position), the tactile sensor is in the high-stiffness range where the stiffness of the tactile sensor responds to the height of the 3D structures in the given portion (e.g., becomes stiffer as the height of the 3D structures decreases, or the 3D structures are compressed).

The elastic skin 104, including the raised surface texture 116, can be formed from an elastomer (e.g., silicone) or other suitable resilient material. In some examples, the material of the elastic skin 104 is substantially impermeable to the fluid contained in the cell 106 (or the elastic skin 104 can be coated with a material that is substantially impermeable to the fluid contained in the cell 106). In some examples, the elastic skin 104 with the raised surface texture 116 on its inner surface can be formed by molding.

The core 102 can be a relatively rigid core (e.g., more rigid compared to the elastic skin 104). For example, the core 102 can be formed from hard plastic or metal. In the illustrated example, the core 102 is nonplanar and has a shape of a tip of a distal phalanx (or a fingertip shape). In other examples, the core 102 may have a different nonplanar shape or a planar shape. In the illustrated example, the ventral surface 110 of the core 102 is a curved surface. The ventral surface 110 includes an inclined flattened region 121 (shown in FIG. 2A) corresponding to an apical tuft of a distal phalanx. In some examples, the angle 123 of the inclined flattened region 121 relative to a plane parallel to a dorsal surface 124 of the core 102 may be in a range from 30 to 45 degrees. In some examples, the tuning gap G that separates the raised surface texture 116 from the ventral surface 110 may have a different size (e.g., a larger size) in the inclined flattened region 121 compared to other regions of the ventral surface 110.

The dorsal surface 124 of the core 102 can include an annular groove 126 that receives a peripheral portion 128 of the elastic skin 104. The annular groove 126 may have an undercut to assist in locking the peripheral portion to the core 102. In some examples, the tactile sensor 100 can include a dorsal plate 130 that can be mounted on the dorsal surface 124 of the core 102. The dorsal plate 130 can extend over the peripheral portion 128 of the elastic skin 104 such that when the dorsal plate 130 is clamped to the core 102, the dorsal plate 130 can apply a force to the peripheral portion 128 that enables the peripheral portion 128 to function as a gasket sealing the cell 106 at the perimeter of the core 102. The dorsal plate 130 may be clamped to the core 102, for example, by inserting threaded fasteners 129 into aligned holes 131 in the dorsal plate 130 and threaded holes 133 in the core 102 and making up the threads between the threaded fasteners 129 and the threaded holes 133. Other methods of sealing the elastic skin 104 to the core 102 at the perimeter of the core 102 may be used (e.g., sealing with O-rings or diaphragms).

The core 102 can include a pressure communication port 137 fluidly connected to the cell 106. In the illustrated example, the pressure communication port 137 includes a chamber 132, which may be accessible through an opening 140 in the dorsal plate. The pressure communication port 137 includes a channel 134 that is connected to the chamber 132 at one end and to the ventral surface 110 at another end. The pressure transducer 114 is disposed at least partly within the pressure communication port 137 (e.g., within a portion of the channel 134 adjacent to the chamber 132). The proximity of the pressure transducer 114 to the ventral surface 110 of the cell 106 may be controlled by the length of the channel 134.

The pressure transducer 114 is exposed to the fluid pressure in the cell 106 via the channel 134 (or pressure communication port 137). The pressure transducer 114 includes a pressure-sensitive element that can measure fluid pressure and convert the measurements into an electric output signal. The pressure transducer 114 can be, for example, a strain gauge pressure transducer. In some cases, the pressure transducer 114 may further include a temperature sensor. In some examples, temperature measurements from the temperature sensor may be used in interpreting the pressure measurements.

The pressure transducer 114 can be coupled to a circuit board 136 and may be disposed in the pressure communication port 137 via mounting of the circuit board 136 in the chamber 132. For example, the circuit board 136 can be mounted on a seat 135 formed in the chamber 132 such that the pressure transducer 114 extends into the channel 134. The circuit board 136 contains electrical circuity that can communicate with the pressure transducer 114 (e.g., receive electrical output signals from the pressure transducer 114 and provide electrical power to the pressure transducer 114). The circuit board 136 may be coupled to a sensor adapter 139 mounted in the opening 140 in the dorsal plate 130 and may be communicatively coupled to other systems of the robot.

In the illustrated example, the circuit board 136 is mounted on the seat 135 of the chamber 132 and extends over the opening of the channel 134 at the base of the chamber 132. A fluid leakage path between the seat 135 and the circuit board 136 may be sealed (e.g., by disposing epoxy at the interface between the circuit board 136 and the seat 135 or by forming an annular groove in the chamber that surrounds a perimeter of the circuit board 136 mounted on the seat 135 and providing a sealing ring or gasket in the annular groove that seals between the inner perimeter of the chamber 132 and the outer perimeter of the circuit board 136).

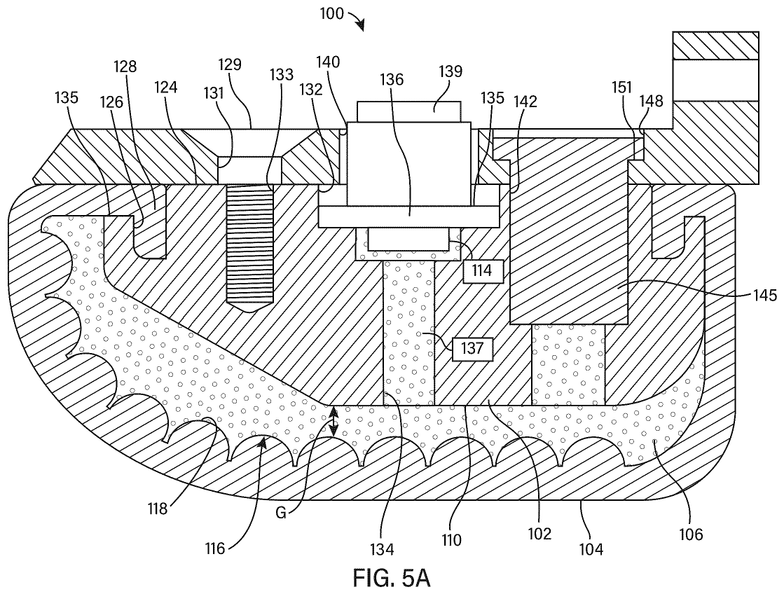

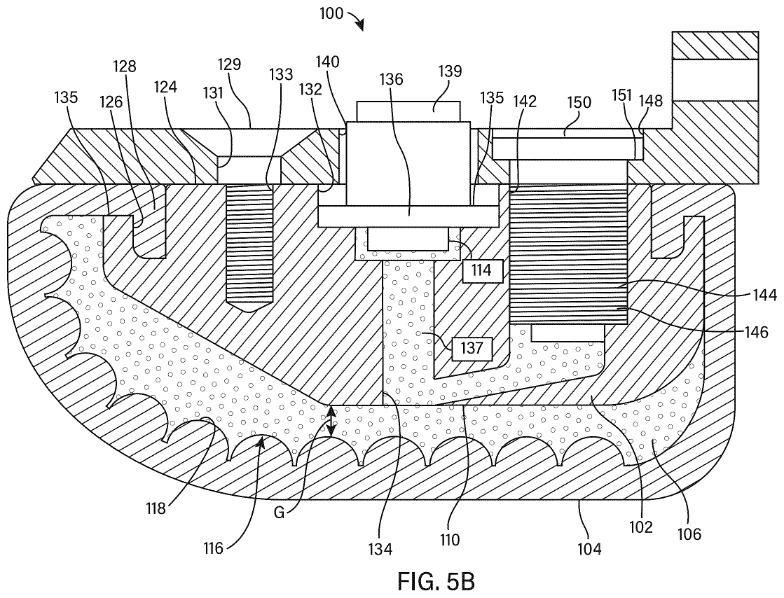

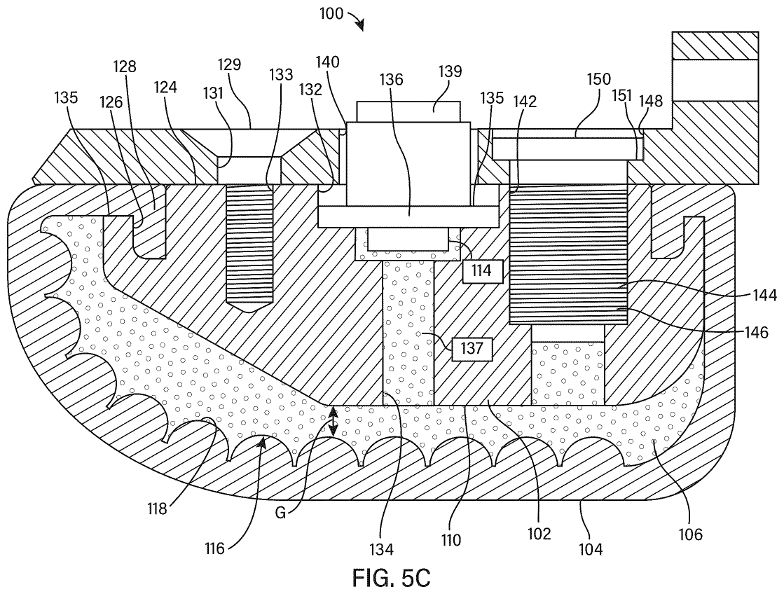

In some examples, as illustrated in FIG. 5A, the core 102 can include an inflation port 142 that is fluidly connected to the cell 106. In the illustrated example, the inflation port 142 extends from the dorsal surface 124 of the core 102 to the ventral surface 110 of the core 102. In other examples, as illustrated in FIG. 5B, the inflation port 142 may extend from the dorsal surface 124 of the core 102, through the core 102, to the pressure communication port 137 (or the channel 134) (i.e., the inflation port 142 may be fluidly connected to the cell 106 via the pressure communication port 137). In some examples, the dorsal plate 130 may have a hole 148 (or opening) that is aligned with the inflation port 142 so that the inflation port 142 is accessible after the tactile sensor is assembled.

In some examples, as illustrated in FIG. 5A, a removable plug 145 may be mounted in the inflation port 142 that allows filling of the cell 106 after assembling the tactile sensor. The removable plug 145 may have a flange that engages a shoulder 151 formed in the hole 148 of the dorsal plate 130. In other examples, as illustrated in FIGS. 5B and 5C, a valve 144 may be installed in the inflation port 142 and used to inflate or reinflate the cell 106 with fluid as needed. The fluid may be pressurized fluid or ambient fluid (e.g., air). In some examples, the valve 144 may work passively to inflate the cell 106 when the pressure of the fluid in the cell 106 is below ambient pressure. In some examples, the valve 144 may be a miniaturized one-way valve.

Referring to FIG. 5C, the valve 144 may be installed in the inflation port 142 using any suitable method. In some examples, the valve 144 may have a threaded body 146 that threadedly engages the inflation port 142. A threaded sealant may be applied to the threaded connection to seal the cell 106 at the perimeter of the inflation port 142. The valve 144 may have a cap 150 that engages the shoulder 151 (or seat) formed in the hole 148 of the dorsal plate 130. A sealant (e.g., epoxy may be provided between the cap 150 and shoulder 151 or between the perimeter of the cap 150 and wall of the hole 148) to further seal the cell 106 at the perimeter of the hole 148. A seal may be provided between the shoulder 151 and cap 150 (or between the cap 150 and a wall of the hole 148). In general, any suitable method of installing the valve 144 in the inflation port 142 and sealing the cell 106 at the perimeter of the inflation port 142 may be used.

### Example III—Robotic Finger With Tactile Sensor

FIG. 6 shows the tactile sensor 100 coupled to a distal phalanx 101 of a robotic finger (e.g., by coupling the dorsal plate 130 to the distal phalanx 101). The distal phalanx 101 is shown coupled to a proximal phalanx 103, which can be coupled to other parts of the robotic finger not shown (e.g., metacarpal).

### Additional Examples

Additional examples based on principles described herein are enumerated below. Further examples falling within the scope of the subject matter can be configured by, for example, taking one feature of an example in isolation, taking more than one feature of an example in combination, or combining one or more features of one example with one or more features of one or more other examples.
Example 1: A tactile sensor comprises a cell containing a fluid medium; a core having a ventral surface and a dorsal surface, the ventral surface forming a first boundary of the cell; an elastic skin having an inner surface and an outer surface, the inner surface in opposing relation to the ventral surface and forming a second boundary of the cell, the inner surface having a raised surface texture protruding into the cell, wherein a force applied to the elastic skin deforms the elastic skin and causes a change in fluid pressure inside the cell; and a pressure transducer arranged to measure the fluid pressure inside the cell.
Example 2: The tactile sensor according to Example 1 wherein a tuning gap is defined between the raised surface texture and the ventral surface.
Example 3: The tactile sensor according to Example 2, wherein a height of the tuning gap across the cell is non-uniform.
Example 4: The tactile sensor according to Example 2 or 3, wherein a given portion of the raised surface texture is movable between a free position in which a height of the tuning gap is non-zero and an engaged position in which the height of the tuning gap is zero, and wherein the given portion of the raised engages the ventral surface in the engaged position.
Example 5: The tactile sensor according to Example 4, wherein the height of the tuning gap at the given portion of the raised surface texture controls a first sensor stiffness range, and wherein a height of the given portion of the raised surface texture controls a second sensor stiffness range that is different from the first sensor stiffness range.
Example 6: The tactile sensor according to any one of Examples 2-5, wherein the given portion of the raised surface texture forms a compression spring in the engaged position that deforms responsively to the force applied to the elastic skin, and wherein the given portion of the raised surface texture releases itself from the engaged position when the force is removed from the elastic skin.
Example 7: The tactile sensor according to any one of Examples 1-6, wherein a peripheral portion of the elastic skin is mechanically coupled to the core.
Example 8: The tactile sensor according to Example 7, wherein the dorsal surface of the core includes an annular groove, and wherein the peripheral portion of the elastic skin extends into and sealingly engages the annular groove.
Example 9: The tactile sensor according to any one of Examples 1-8, wherein the core includes a pressure communication port fluidly connected to the cell, and wherein the pressure transducer is disposed at least partly within the pressure communication port and exposed to the fluid pressure inside the cell via the pressure communication port.
Example 10: The tactile sensor according to Example 9, further comprising a circuit board with circuitry mechanically and communicatively coupled to the pressure transducer.
Example 11: The tactile sensor according to Example 11, wherein the circuit board is disposed on a seat formed in the pressure communication port, and wherein a fluid leakage path between the circuit board and the seat is sealed.
Example 12: The tactile sensor according to any one of Examples 1-11a, wherein the raised surface texture comprises discrete 3D structures arrayed across the inner surface of the elastic skin.
Example 13: The tactile sensor according to Example 12, wherein at least one of the 3D structures has a spherical profile.
Example 14: The tactile sensor according to any one of Examples 1-13, wherein the raised surface texture comprises intersecting 3D structures extending across the inner surface of the elastic skin.
Example 15: The tactile sensor according to Example 14, wherein the 3D structures are linear 3D structures.
Example 16: The tactile sensor according to Example 14, wherein the intersecting 3D structures form a waffle structure (e.g., having a crisscross pattern).
Example 17: The tactile sensor according to any one of Examples 1-16, wherein the core includes an inflation port extending from the dorsal surface to the ventral surface.
Example 18: The tactile sensor according to Example 17, further comprising a valve installed in the inflation port.
Example 19: The tactile sensor according to Example 18, wherein the valve is a miniaturized one-way valve.
Example 20: The tactile sensor according to any one of Examples 1-19, wherein the ventral surface of the core is nonplanar.
Example 21: The tactile sensor according to Example 20, wherein the ventral surface of the core comprises an inclined flattened region corresponding to an apical tuft of a fingertip, and wherein a size of the tuning gap at the inclined flattened region is different than a size of the tuning gap at other regions of the ventral surface.
Example 22: The tactile sensor according to any one of Examples 121, wherein the elastic skin comprises an elastomer.
Example 23: The tactile sensor according to any one of Examples 1-22, wherein the fluid medium is a compressible fluid.
Example 24: The tactile sensor according to any of Examples 1-23, wherein the fluid medium is air.

1. A tactile sensor comprising:
a cell containing a fluid medium;
a core having a ventral surface and a dorsal surface, the ventral surface forming a first boundary of the cell;
an elastic skin having an inner surface and an outer surface, the inner surface in opposing relation to the ventral surface and forming a second boundary of the cell, the inner surface having a raised surface texture protruding into the cell, wherein a force applied to the elastic skin deforms the elastic skin and causes a change in fluid pressure inside the cell; and
a pressure transducer arranged to measure the fluid pressure inside the cell.

2. The tactile sensor of claim 1, wherein a tuning gap is defined between the raised surface texture and the ventral surface.

3. The tactile sensor of claim 2, wherein a height of the tuning gap across the cell is non-uniform.

4. The tactile sensor of claim 2, wherein a given portion of the raised surface texture is movable between a free position in which a height of the tuning gap is non-zero and an engaged position in which the height of the tuning gap is zero, and wherein the given portion of the raised surface texture engages the ventral surface in the engaged position.

5. The tactile sensor of claim 4, wherein the height of the tuning gap at the given portion of the raised surface texture controls a first sensor stiffness range, and wherein a height of the given portion of the raised surface texture controls a second sensor stiffness range that is different from the first sensor stiffness range.

6. The tactile sensor of claim 4, wherein the given portion of the raised surface texture forms a compression spring in the engaged position that deforms responsively to the force applied to the elastic skin, and wherein the given portion of the raised surface texture releases itself from the engaged position when the force is removed from the elastic skin.

7. The tactile sensor of claim 1, wherein the raised surface texture comprises discrete 3D structures arrayed across the inner surface of the elastic skin.

8. The tactile sensor of claim 7, wherein at least one of the 3D structures has a spherical profile.

9. The tactile sensor of claim 1, wherein the raised surface texture comprises intersecting 3D structures extending across the inner surface of the elastic skin.

10. The tactile sensor of claim 9, wherein the 3D structures are linear 3D structures.

11. The tactile sensor of claim 9, wherein the intersecting 3D structures form a waffle structure.

12. The tactile sensor of claim 2, wherein the ventral surface of the core is nonplanar.

13. The tactile sensor of claim 12, wherein the ventral surface of the core comprises an inclined flattened region corresponding to an apical tuft of a fingertip, and wherein a size of the tuning gap at the inclined flattened region is different than the size of the tuning gap at other regions of the ventral surface.

14. The tactile sensor of claim 1, wherein the core includes a pressure communication port fluidly connected to the cell, and wherein the pressure transducer is disposed at least partly within the pressure communication port and exposed to the fluid pressure inside the cell via the pressure communication port.

15. The tactile sensor of claim 14, further comprising a circuit board with circuitry mechanically and communicatively coupled to the pressure transducer

16. The tactile sensor of claim 1, wherein the core includes an inflation port fluidly connected to the cell, and wherein the cell is fillable with the fluid medium via the inflation port.

17. The tactile sensor of claim 16, further comprising a valve installed in the inflation port.

18. The tactile sensor of claim 17, wherein the valve is a miniaturized one-way valve.

19. The tactile sensor of claim 1, wherein the elastic skin comprises an elastomer, and wherein the fluid medium is a compressible fluid.

20. The tactile sensor of claim 19, wherein the fluid medium is air.
